(19) United States
(12) Patent Application Publication
(10) Pub. No.: US 2026/0360029 A1
(43) Pub. Date: Nov. 12, 2026

(54) METHOD FOR RECORDING A DIGITAL IMAGE

(71) Applicant: FOGALE NANOTECH, Nîmes (FR)

(72) Inventors: Eric LEGROS, Nîmes (FR); Sylvain PETITGRAND, Caissargues (FR)

(21) Appl. No.: 18/997,618

(22) PCT Filed: Jul. 25, 2023
(86) PCT No.: PCT/EP2023/070554

§ 371 Date: Jan. 22, 2025

(30) Foreign Application Priority Data
Jul. 27, 2022 (FR) 2207740

(51) Int. Cl. G06T 11/40; G06T 11/10; G06T 11/60; H04N 9/80; H04N 19/186; H04N 19/63

(52) U.S. Cl. CPC G06T 11/40; G06T 11/10; G06T 11/60; H04N 9/80; H04N 19/186; H04N 19/63; G06T 2210/32

(57) ABSTRACT

A method for recording a digital image in a computer format, the image, or at least a portion of the image, being coded and recorded in the form of a matrix of pixels in which each subject pixel, from among at least one or more pixels of the matrix, includes at least one dividing line within the subject pixel, dividing the subject pixel at least into two domains, and/or being able to make this line visible and/or—at least one spatial color and/or shade and/or brightness gradient within the subject pixel or within at least one of the domains of the subject pixel.

### TECHNICAL FIELD

The present invention relates to a method for recording a digital image in a computer format, as well as to a method of displaying, pixelating, rasterizing, compressing, and/or decompressing such an image, and to a computer program product comprising computer code instructions for executing any of these methods.

The field of the invention is more particularly but not exclusively that of images acquired by a digital sensor, within a smartphone or touchscreen tablet or webcam or digital camera or digital single-lens reflex or bridge camera, or other.

### PRIOR ART

Image formats represented by pixels, or bitmaps, or raster images are known, one pixel of which is shown in FIG. 1a.

Vectorized or vector image formats are known.

A vector image is made up of geometric objects such as line segments, arcs of circles or, more generally, curves, which define lines of a certain thickness, as well as surfaces of various shapes, generally delimited by polygons or other shapes derived from curves.

These objects can be superimposed. In this case, an order of representation is defined to determine which object is represented first and partially hidden by others, and so on. The advantage of this representation is that, in the event of enlargement, it is possible to retain precise definition of object outlines, for example, or filled-in areas, which is not possible with so-called raster images, where pixels are perceived beyond a certain magnification.

Images represented in raster format are therefore difficult to enlarge. Such enlargement creates a pattern of pixels that become very big when the image is enlarged. These enlarged images are unpleasant to look at, as they contain a mosaic of pixels. What's more, pixel vision can cause the information contained in the image to be lost or blurred. This can be seen by enlarging an image of text at the pixel resolution limit. When enlarged, the meaning of what is written is often lost.

Vector images tend to look “artificial”, too perfect. In fact, they can be the result of primitive drawings, such as a rectangle, a circle or a closed polygon filled with a certain color. Real-world images almost invariably feature brightness gradations, due in part to their variable inclination to light sources, and to the non-homogeneity of these sources. What's more, real-world objects are very often covered with defects such as scratches, dust of varying degrees of fineness, light-related discolorations, fabric wefts, tree leaf veins, rope strands, hair and so on. Furthermore, living beings and animals generally have more asperities than objects not directly derived from nature, such as wrinkles, hair, fur, redness, wood grains, etc. all of which are very different from a pure geometric primitive, unless it is given a very small size, which can multiply the number to the extreme.

Some vectorized image languages, such as VML, allow you to add filters that blur the edges of images, making them less sharp and more like real images. They also enable color gradients to be applied, making these primitives less uniform in texture, corresponding to notions of color gradients added to the properties of a surface delimited by an object in order to better represent the effects of reality.

The effects of vectorization can be seen, for example, in the loss of detail in light-colored bands wrapped around a hat, which contain a weft or wrinkle in the fabric perpendicular to the bands, which disappears with vectorization. In the same way, a fur coat loses its thread-like details, becoming a continuous mass, and so does hair. Note that despite these losses, the vectorized image can still contain a notion of color gradient. The presence of these gradients is not enough to restore the notions of hair and the details of the fabric strips. This example confirms that vectorization of an image is generally unable to reproduce all its nuances, unless extremely fine objects are used, such as a curve for each hair. In the latter case, the result would be an extreme quantity of objects, weighing down the reproduction.

So, despite improvements such as the ability to take gradients into account, images obtained by vectorization generally retain a perceptible artificial character, unless a huge number of objects are used, or numerous effects are applied, as can be done in software for rendering digital games, or digital synthesis of film images, at the cost of numerous calculations.

Vectorized images are therefore not a suitable format for reproducing photographs, which by their very nature feature an extreme diversity of textures, shadows, gradations and micro-defects. Also, software tools exporting images from camera modules (for single image photography, or multiple images constituting a film), intrinsically work on pixel fields or rasters, and compress them in formats compatible with this pixel field representation (such as .jpeg, .png), to reduce the file size of these images or videos.

However, these raster images cannot be enlarged, unless the quality of contours, lines and textures with significant spatial variation is significantly reduced during viewing, and unless they are initially generated with very fine spatial sampling in line with the maximum foreseeable enlargement, which generates a very large number of pixels and very large associated files, even with compression.

Finally, in this prior art, it should be noted that the raster image is potentially much faster to render, as all that is required is to go through the image's pixel data table in a double loop. For a vectorized image, each object in a list of objects needs to be scanned in increments of the desired rendering density, for example to create the output of this image to a raster representation compatible with a display screen, that is, according to the step size of these pixels. If the number of objects is very high, to represent all the richness of a real image, for example to obtain details such as texture, these calculations can represent a much greater amount of computation than raster image processing, for a given rendered quality.

The purpose of the present invention is to propose a method for recording a digital image in a computer format, making it possible, in comparison with the prior art:
To reduce the impression of artificiality in the image, and/or
To be more suitable for representing photographs and/or images with an extreme diversity of textures, shadows, gradients, micro-defects, and/or
To better support magnification, without significant loss of quality during visualization, on contours, lines, textures with significant spatial variation, and/or
To facilitate compression/decompression or display processing, and/or
to require less data of equivalent quality, and/or
to have better quality for the same amount of data, and/or
to reduce processing time.

### DISCLOSURE OF THE INVENTION

This objective is achieved with a (typically computer-implemented) method of recording a digital image in a computer format, said image or at least a portion of the image being coded and recorded in the form of a matrix of pixels wherein each subject pixel from among at least one or more pixels of the matrix comprises:
at least one dividing line within the subject pixel, dividing the subject pixel into at least two domains, and/or
at least one spatial gradient of color and/or shade and/or brightness within the subject pixel or at least one of the domains of the subject pixel. The 2 preceding paragraphs (dividing line and/or spatial gradient) may be claimed alone or in combination.

Each dividing line within the subject pixel can be coded by two data items comprising:
Two points on a periphery of the subject pixel, and/or
A distance, preferably from the center of the subject pixel, and an angle.

Dividing lines between multiple neighboring pixels can be joined together to form a continuous line running through that plurality of neighboring pixels.

The at least one gradient within the subject pixel or the at least one domain of the subject pixel may comprise:
A brightness gradient, and/or
One or more gradients corresponding respectively to one or more color(s) and/or shade(s).

The at least one gradient within the subject pixel or the at least one domain of the subject pixel may be coded by:
two spatial components, or
A single spatial component relative to the at least one dividing line within the subject pixel.

At least one brightness and/or color and/or shade within the subject pixel or the at least one domain of the subject pixel may depend on a brightness and/or color and/or shade of at least one pixel adjacent to the subject pixel or at least one domain of a pixel adjacent to the subject pixel.

At least one brightness and/or color and/or shade gradient within the subject pixel or the at least one domain of the subject pixel may depend on a brightness and/or color and/or shade gradient of at least one pixel adjacent to the subject pixel or at least one domain of a pixel adjacent to the subject pixel.

All pixels in the pixel matrix can have the same dimensions.

The at least one dividing line can have a state that can be viewed with a viewing area.

The at least one dividing line can itself feature a spatial gradient enabling its brightness and/or color and/or shade to be modulated when it can be viewed or visualized.

The at least one dividing line can be switched between its viewable state and a non-viewable state.

The at least one dividing line can be switched between an active state and an inactive state.

The method according to the invention may comprise a deactivation of the at least one dividing line of the subject pixel if this subject pixel is sampled below a certain spatial sampling threshold.

The method according to the invention can be implemented in an embedded manner in a software module that is added to or integrated with a web browser, for taking into account the recorded images, possibly compressing or decompressing them, and/or displaying them on part or all of a screen in interaction with the web browser.

In some embodiments:
textual information represented by symbols pointing in a font, and/or
drawings of embedded objects in the form of raster or vectorized sub-images can be added directly to the recorded image or added during its viewing, so that they can be viewed, possibly according to a particular selection which shows only all or part of them, when the recorded image is played back.

Metadata can be added to the recorded image.

According to still another aspect of the present invention, a method is proposed for:
displaying an initial image as a so-called final image on a screen comprising groups of photogenerators, or
pixelating or rasterizing said initial image into a final image comprising final pixels devoid of dividing lines and/or spatial gradients of color and/or shade and/or brightness within said final pixels,
   said initial image being recorded using a recording method according to the invention,
   characterized in that it comprises:
For each final subject pixel or each subject group of photogenerators, a transcription of at least one initial pixel or at least one initial pixel domain into this subject final pixel or subject group of photogenerators:
   from the brightness and/or color and/or shade components of this at least one initial pixel or at least one initial pixel domain
   to this subject final pixel or subject group of photogenerators, the transcription being made in proportion to this at least one initial pixel or at least one initial pixel domain within a facing common surface between:
this at least one initial pixel or at least one initial pixel domain and
the subject final pixel or subject group of photogenerators.

For transcription purposes, if the subject final pixel or subject group of photogenerators faces different initial pixels and/or domains of initial pixels, its brightness and/or color and/or shade components can be a weighted average in proportion to the respective areas of these different initial pixels and/or domains of initial pixels facing the subject final pixel or subject group of photogenerators.

For transcription purposes, the brightness and/or color and/or shade components of an initial pixel can be modulated by the spatial gradient values of each part of the initial pixel domain facing the subject final pixel or subject group of photogenerators.

A dividing line of an initial pixel can be used to be viewable and contribute to the brightnesses and/or colors and/or shades of at least the subject final pixel or subject group of photogenerators, in proportion to a viewing area of at least a portion of the dividing line facing the subject final pixel or subject group of photogenerators.

According to yet another aspect of the invention, a method is proposed for compressing or decompressing an initial image recorded according to a recording method according to the invention, characterized in that the initial image is compressed or decompressed, respectively, into a compressed or decompressed image, respectively, by decreasing the volume of information representing the compressed image as a result of the compression, or by increasing the volume of information representing the decompressed image as a result of the decompression, the compression or decompression relating to at least one component among the color(s) and/or the shade(s) and/or the brightness and/or the at least one dividing line and/or the at least one spatial gradient within each subject initial pixel.

The initial image can be compressed or decompressed, respectively, so that its content can be viewed directly using a display, pixelation or rasterization method according to the invention.

The initial image can be compressed or decompressed, respectively, by means of a wavelet transformation of each component to be compressed.

The initial image can be compressed or decompressed, respectively, by means of a Discrete Cosine Transform (DCT).

After compression or decompression, the method according to the invention may comprise a search for identical sequences, indexing these sequences and replacing each repeated sequence by its index in an image data or information stream.

The method according to the invention can use lossy compression on at least one component among color(s) and/or shade(s) and/or brightness and/or at least one dividing line and/or at least one spatial gradient of each subject initial pixel or of the at least one divide within each subject initial pixel, and lossless on at least one other component among activation of the at least one divide, and/or visualization of the at least one divide and/or width of the at least one divide.

In yet another aspect of the invention, a computer program product or a computer program comprising instructions is proposed:
computer code for executing any of the processes according to the invention set out above, preferably when said program is executed on a computer, and/or
which, when the program is executed by a computer and/or processor and/or any computing means, lead the latter to implement any of the processes according to the invention previously disclosed.

In yet another aspect of the invention, a (computer-readable) data medium is offered, on which a computer program product or a computer program according to the invention is recorded (preferably in non-volatile fashion).

According to still another aspect of the present invention, proposed is:
a device according to the invention, implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by this device (typically by a lens and/or a sensor of this device), and/or
a use of a method for recording, displaying, pixelating, rasterizing, compressing and/or decompressing according to the invention within a device according to the invention, preferably on an image acquired by this device (typically by a lens and/or a sensor of this device), and/or
a smartphone (also called a multifunction mobile phone), implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by the smartphone (typically by a lens and/or a sensor of the smartphone), and/or
a use of a method for recording, displaying, pixelating, rasterizing, compressing and/or decompressing according to the invention within a smartphone (also called a multifunction mobile phone), preferably on an image acquired by the smartphone (typically by a lens and/or sensor of the smartphone), and/or
a touchscreen tablet, implementing a method for recording, displaying, pixelating, rasterizing, compressing and/or decompressing according to the implement a method for recording, displaying, pixelating, rasterizing, compressing and/or decompressing according to the invention, preferably on an image acquired by this touchscreen tablet (typically by a lens and/or a sensor of this touchscreen tablet), and/or
a use of a method for recording, displaying, pixelating, rasterizing, compressing and/or decompressing according to the invention within a touchscreen tablet according to the invention, preferably on an image acquired by this touchscreen tablet (typically by a lens and/or a sensor of this touchscreen tablet), and/or
a camera (preferably a reflex or bridge or compact camera) implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by this camera (typically by a lens and/or a sensor of this camera),
a use of a method for recording, displaying, pixelating, rasterizing, compressing and/or decompressing according to the invention within a camera (preferably a reflex or bridge or compact camera), preferably an image acquired by the camera (typically by a lens and/or a sensor of the camera), and/or
a vehicle (preferably a motor vehicle, but which may be of any type), implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing, according to the invention, preferably on an image acquired by the vehicle typically equipped with a lens and/or a sensor, this image preferably being used or intended to be used by the vehicle for autonomous driving of the vehicle, and/or
a use of a method for recording, displaying, pixelating, rasterizing, compressing and/or decompressing according to the invention within a vehicle (preferably a motor vehicle, but which may be of any type), to correct an image acquired by the vehicle (typically by a lens and/or a sensor of the vehicle); the image preferably being used or intended to be used by the vehicle for autonomous driving of the vehicle, and/or
a video surveillance system (preferably of a building or geographical area) implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by the video surveillance system (typically by a lens and/or a sensor of the video surveillance system), and/or
a use of a method for recording, displaying, pixelating, rasterizing, compressing and/or decompressing according to the invention within a video surveillance system (preferably of a building and/or a geographical area), preferably on an image acquired by the video surveillance system (typically by a lens and/or a sensor of the video surveillance system), and/or
a drone implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing, according to the invention, preferably on an image acquired by the drone (typically by a lens and/or a sensor of the drone); this image preferably being used or intended or to be used by the drone:
   in the field of agriculture, the image acquired by the drone preferably being an image of plant crops, and/or
   in the field of pollution and/or land use analysis, the image acquired by the drone preferably being a multispectral image, and/or
a use of a method for recording, displaying, pixelating, rasterizing, compressing and/or decompressing according to the invention within a drone, preferably on an image acquired by the drove (typically by a lens and/or a sensor of the drone); this image preferably being used or intended to be used by the drone:
   in the field of agriculture, the image acquired by the drone preferably being an image of plant crops, and/or
   in the field of pollution and/or land use analysis, the image acquired by the drone preferably being a multispectral image, and/or
a satellite implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing, according to the invention, preferably on an image acquired by the satellite (typically by a lens and/or a sensor of the satellite); the image preferably being used or intended or to be used by the satellite:
   in the field of agriculture, the image acquired by the satellite preferably being an image of plant crops, and/or
   in the field of pollution and/or land use analysis, the image acquired by the satellite preferably being a multispectral image, and/or
a use of a method for recording, displaying, pixelating, rasterizing, compressing and/or decompressing according to the invention within a satellite, preferably on an image acquired by the drove (typically by a lens and/or a sensor of the satellite); this image preferably being used or intended to be used by the satellite:
   in the field of agriculture, the image acquired by the satellite preferably being an image of plant crops, and/or
   in the field of pollution and/or land use analysis, the image acquired by the satellite preferably being a multispectral image, and/or
a medical imaging device for imaging the human and/or animal body (preferably by MRI and/or X-ray and/or Gamma-ray and/or ultrasound), implementing a method for recording, displaying, pixelating, rasterizing, compressing and/or decompressing according to the invention and/or comprising technical means arranged and/or programmed to implement a decompressing according to the invention, preferably on an image acquired by the medical imaging device (typically by a lens and/or a sensor of the medical imaging device), and/or
a use of a method for recording, displaying, pixelating, rasterizing, compressing and/or decompressing according to the invention within a medical imaging device for imaging the human and/or animal body (preferably by MRI and/or X-ray and/or Gamma-ray and/or ultrasound), preferably on an image acquired by the medical imaging device (typically by a lens and/or a sensor of the medical imaging device), and/or
a microscope, implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by this microscope (typically by a lens and/or a sensor of this microscope), and/or
a use of a method for recording, displaying, pixelating, rasterizing, compressing and/or decompressing according to the invention within a microscope, preferably an image acquired by the microscope (typically by a lens and/or a sensor of the microscope), and/or
a tomographic imaging apparatus for an image acquired across multiple spectra (preferably in the field of healthcare and/or in the field of industry and/or in the field of agriculture), implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by the tomographic imaging apparatus (typically by a lens and/or a sensor of the tomographic imaging apparatus), and/or
a use of a method for recording, displaying, pixelating, rasterizing, compressing and/or decompressing according to the invention within a tomographic imaging apparatus of an image acquired in several wavelength bands (preferably in the field of health and/or in the field of industry and/or in the field of agriculture), preferably on an image acquired by the tomographic imaging apparatus (typically by a lens and/or a sensor of the tomographic imaging apparatus).

### DESCRIPTION OF THE FIGURES AND EMBODIMENTS

Other benefits and features shall become evident upon examining the detailed description of entirely non-limiting embodiments and implementations, and from the following enclosed drawings:

FIG. 1a shows a pixel according to the prior art, having three color properties R, G, B. Its position is that of its X, Y position, represented by the indexing to access it, which translates its position in the image,

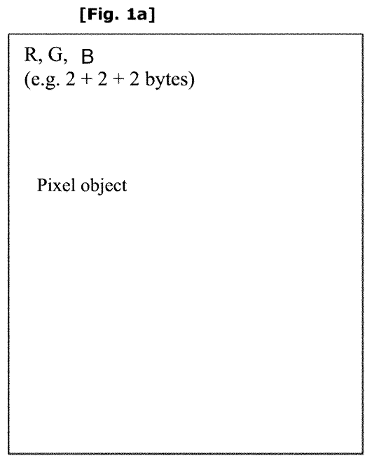

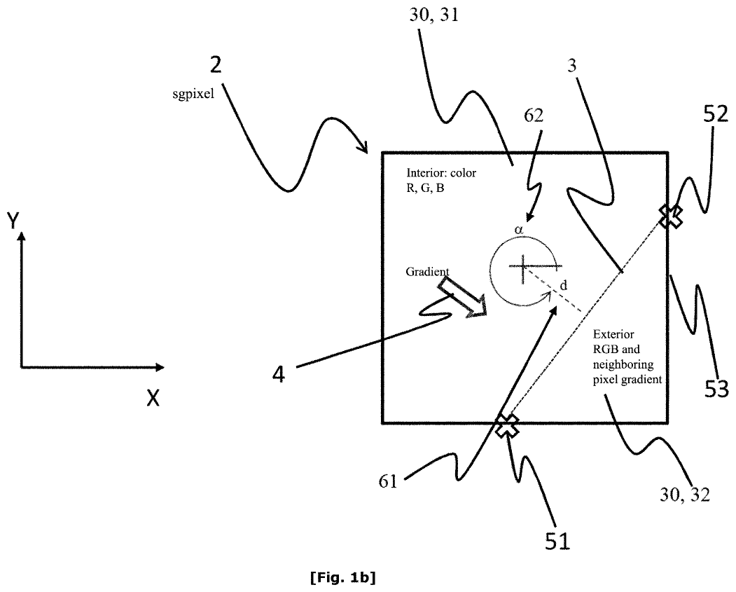

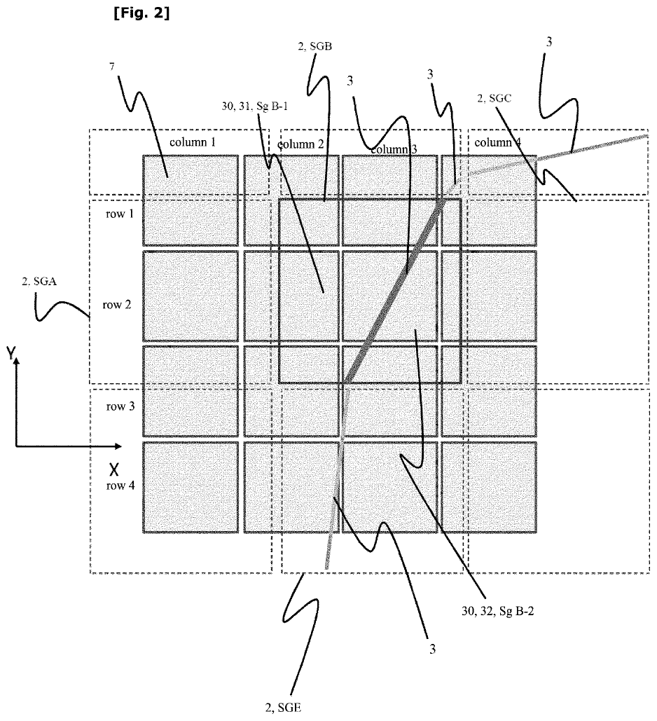

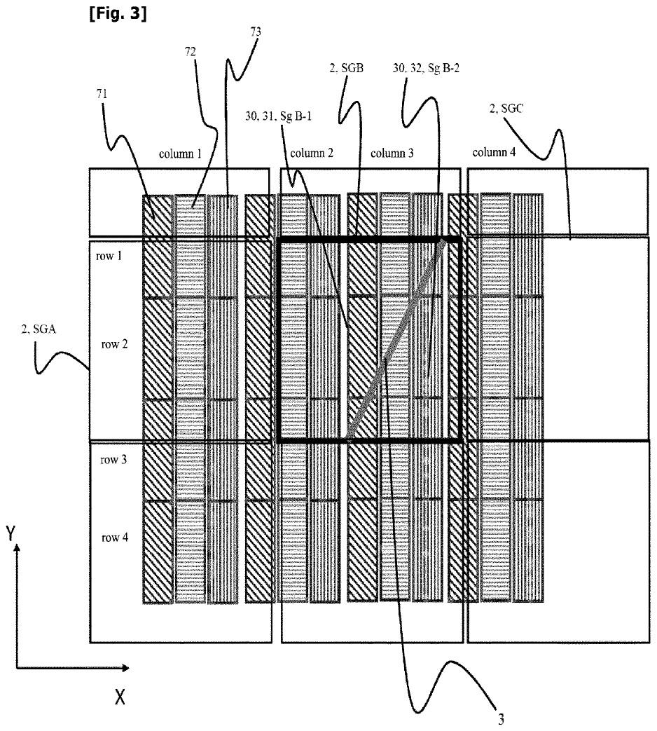

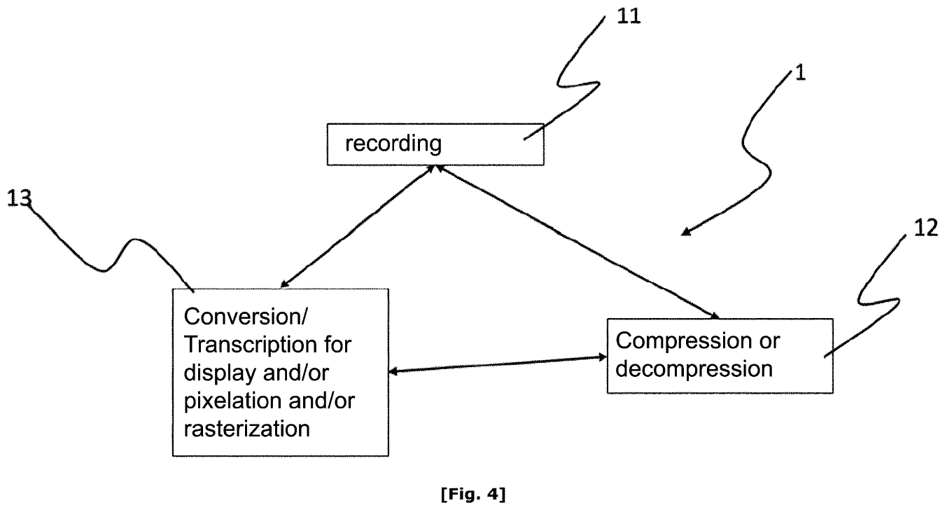

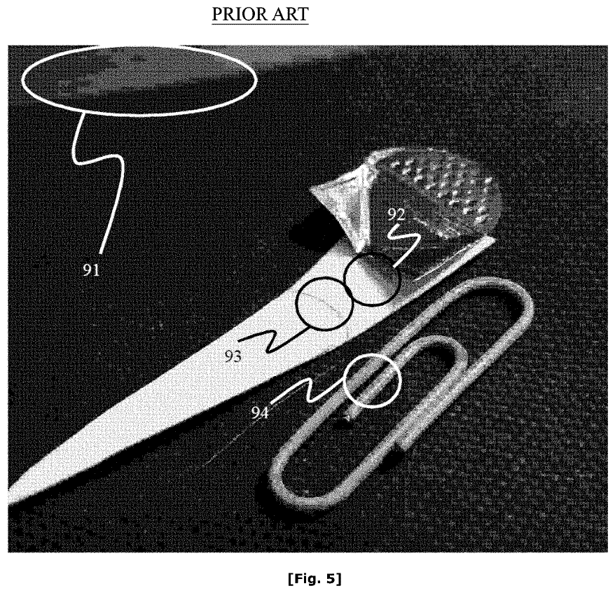

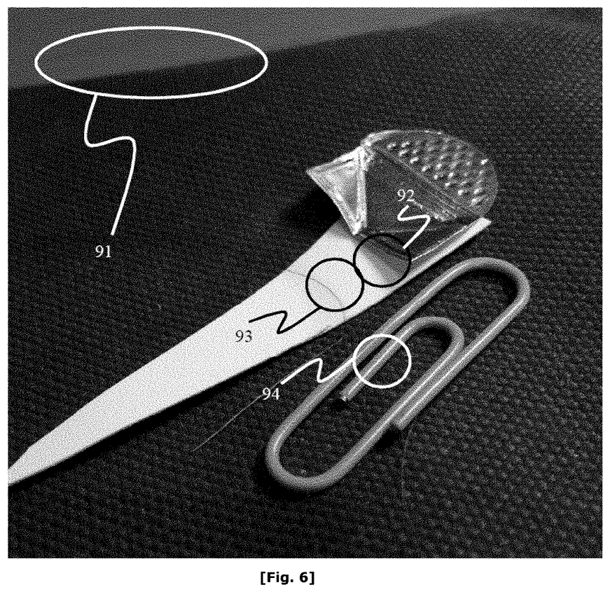

FIG. 1b shows a pixel 2 according to the invention, called sgpixel, comprising:
a number α (e.g. 1 byte), referenced 62, representing an angle (e.g. with respect to the horizontal) of the line passing through the center of pixel 2 and perpendicular to a dividing line 3 within that pixel 2,
an algebraic (that is, signed) distance d, referenced 61, which marks the distance between the center of the pixel and the divide 3 in the sgpixel 2, and thus marks, with a, the position of the divide 3 in sgpixel 2,
A gradient 4 is applied, for example, to the brightness, and therefore the 3 colors, to define a variation in brightness within the sgpixel 2, or more precisely within one of the domains 31 of the sgpixel 2. The direction of the gradient 4 is assumed to be parallel to the distance segment 61 and therefore perpendicular to the divide 3 (so the direction of the gradient 4 is positioned by the angle 62). In another embodiment, the gradient 4 is represented by two coordinates in the X, Y reference frame.

FIG. 2 shows the conversion of a sgpixel image 2 recorded using the method 1 according to the invention and to be converted to a 4×4 matrix of final pixels 7 of a conventional bitmap image or of groups 7 of photogenerators (solid squares) of a screen displaying the sgpixel image 2,

FIG. 3 shows a variant of FIG. 2 which takes into account the exact position of the generators R, G, B in each final pixel 7 of the screen,

FIG. 4 shows various steps 11, 12, 13 of the method 1, which can be repeated multiple times and in any order,

FIG. 5 shows a raster image according to the prior art,

FIG. 6 shows an image according to the invention with sgpixels according to the invention.

These embodiments are in no way limiting, and in particular, it is possible to consider variants of the invention that comprise only a selection of the features disclosed hereinafter in isolation from the other features disclosed (even if that selection is isolated within a phrase comprising other features), if this selection of features is sufficient to confer a technical benefit or to differentiate the invention with respect to the prior art. This selection comprises at least one preferably functional feature which lacks structural details, and/or only has a portion of the structural details if that portion is only sufficient to confer a technical benefit or to differentiate the invention with respect to the prior state of the art.

With reference to FIGS. 1b and 2 to 4, exemplary embodiments of a method 1 according to the invention will first be described.

These examples therefore concern a method 1 for recording 11 (in a random access memory and/or in a read-only memory and/or a computer or any other computer means or system) a digital image in a computer format, said image or at least portion of the image being coded and recorded 11 in the form of a matrix of pixels wherein each subject pixel 2 (called sgpixel as explained below) from among at least one or more or all of the pixels in the matrix comprises:
at least one dividing line 3 (straight or curved, preferably straight) within the subject pixel 2, dividing the subject pixel 2 into at least two domains 30 (distinguished by references 31 and 32 in FIGS. 1b, 2 and 3 corresponding to the case of a single line 3 dividing into two domains 30; in variants, there may be two, three, four or more lines 3 dividing a sgpixel 2 into three, four, five or more domains 30, these lines possibly crossing or touching), and/or
at least one spatial gradient 4 of color (e.g. one gradient 4 per color) and/or shade (e.g. one gradient 4 per shade) and/or brightness within the subject pixel 2 or within at least one of the domains 30, 31, 32 of the subject pixel 2.

The terms “gradient 4” and “variability 4” and “variation 4” and “spatial variation 4” are used interchangeably in this description.

The terms “dividing line 3” and “divide 3” are used interchangeably in this description.

Each sgpixel comprises at least one dividing line 3 and/or at least one gradient 4 in that it includes data relating to this at least one dividing line 3 and/or at least one gradient 4, even if only some of them would have non-null divide 3 or gradient 4 properties. In effect, this makes it possible to standardize the memory representation; otherwise, it creates the obligation to make variable-size fields, but on the other hand, these variable-size fields can take up less memory space overall, if few pixels are involved, and not allocating memory to the null divide 3 and/or gradient 4 fields can already be seen as being a form of compression.

LZ77 coding is a way of replacing repeating sequences with a reference to a previous identical sequence, thus avoiding the need to rewrite the sequence, which is simply replaced by its location and length, thus taking up much less space. In a similar way, if we reduce the notion of sequence to the three components R, G, B of a pixel, the TIFF format—is also a way of compressing an image by replacing repeated identical codes for pixels in a line with the same color, with a sequence that says at once: “there are n fields of this color in the n pixels that follow”, for example.

In this way, the method 1 is implemented by adding properties to each sgpixel 2 among all or some of the pixels of the image representation:
by the at least one gradient 4, a property of spatial variation of color(s) and/or brightness and/or shade(s) within the sgpixel 2 can be added. Different embodiments are possible.
by the at least one dividing line 3, a division property can be added within the sgpixel 2.

Preferentially, in order to obtain the best advantages of the invention, it is recommended to add the possibility of these two properties 3, 4 together for the sgpixels 2. However, the addition of just one of these properties 3, 4 already brings a significant improvement. For the at least one dividing line 3, the contours of the objects are significantly improved when enlarged. For at least one gradient 4, the textures of the objects are significantly sharper, with no pixel crenelations on gradients of color(s) and/or brightness and/or shade(s) for objects with sharp contours not parallel to the main axes of the image (that is, different from 0°, 90°, and also 45° and −45°), which are the least well rendered by the prior art.

By default, all angle values in this description are given with respect to the horizontal X axis of pixel matrix 2 or 7.

We refer to pixels modified 2 by the method 1 as sgpixels 2 in the following, “sg” standing for “separable and gradable” (to indicate the notion of rate of spatial variation of one or more of the pixel's color, shade or brightness components).

Preferably, the pixel matrix comprises or consists of a matrix of sgpixels 2.

The axes of the image plane, perpendicular to each other, are called X and Y. If used, the Z axis is perpendicular to X and Y.

The method 1 can be applied to images featuring a transparency channel (generally referred to as the Alpha channel), or any other complementary channel.

Each dividing line 3 within the subject sgpixel 2 is coded by two items of data comprising:
Two points 51, 52 on a periphery 53 of the sgpixel 2 in question, and/or
A distance 61, preferably from the center of the subject sgpixel 2, and an angle 62.

Preferably all sgpixels 2 and/or generally all pixels of the pixel matrix have the same dimensions, but a variant with different dimensions is also possible. Thus:
preferentially, these sgpixels 2 are arranged in a predefined order in rows and columns (or vice versa), based on a global definition of the number of rows and columns, and a global definition of their dimension ratio if it is not equal to 1. This eliminates the need to write a position and/or contour property for each sgpixel 2, which is implicitly deduced from the position in the table. This facilitates elementary iterative processing. This arrangement is already known in the prior art for the bitmap representation of an image;
but if the image to be represented is endowed with very sparsely populated regions of significant surface area, one may opt for an implementation that adds variable position and/or dimension properties to each sgpixel 2, for example obtained by a code that points to a table or global convention. For example, one may decide on 2 types of sgpixels 2, elementary squares of dimension u×u, and the other type of squares of dimension 2u× 2u. All that is needed is a bit of information to know what type of sgpixel 2 it is, and a rule to convert the position in the table into a position in the image, taking into account the cumulative widths of the sgpixels 2 previously encountered.

The method 1 is preferably implemented in an embedded manner in a software module that is added to or integrated with a web browser, for taking into account the images recorded according to method 1, possibly compressing or decompressing them 12 as described below, and/or viewing or displaying them 13 in part or all of a screen in interaction with the web browser.

Likewise:
textual information represented by symbols pointing in a font, and/or
drawings of embedded objects in the form of raster or vectorized sub-images can be added directly to the image recorded according to claim 1 or added during its viewing 13, so that they can be viewed, possibly according to a particular selection which shows only all or part of them, when the recorded image is rendered.

In this way, the method 1 can be applied:
to images that receive (from another channel) textual information coded by character codes, activating symbols on the image (such as subtitling, for example, or superimposing characters), and/or
to images that receive vectorized elements in addition to pixels.

Similarly, metadata can be added to the image recorded according to the method 1.

Implementation of the Gradient Property 4 (or Spatial Variation) of Color(s) and/or Shade(s) and/or Brightness

Referring to FIG. 2, it can be seen that dividing lines 3 of a plurality of neighboring sgpixels 2 can be assembled by juxtaposition to form a continuous line running through these multiple neighboring sgpixels 2.

Each subject sgpixel 2 can have 8 neighboring pixels or sgpixels (if not located on an edge of the pixel matrix):
at the top of this sgpixel: a NORTH neighboring pixel or sgpixel, for which one may later use an index N
at the bottom of this sgpixel: a SOUTH pixel or neighboring sgpixel, for which one may later use an index S
at the left of this sgpixel: a WEST neighboring pixel or sgpixel, for which one may later use an index W
at the right of this sgpixel: an EAST neighboring pixel or sgpixel, for which one may later use an index E
at the top-left of this sgpixel: a NORTHWEST neighboring pixel or sgpixel, for which one may later use an index NW
at the top-right of this sgpixel: a NORTHEAST neighboring pixel or sgpixel, for which one may later use an index NE
at the bottom-left of this sgpixel: a SOUTHWEST neighboring pixel or sgpixel, for which one may later use an index SW
at the bottom-right of this sgpixel: a SOUTHEAST neighboring pixel or sgpixel, for which one may later use an index SE.

The at least one gradient 4 within the subject sgpixel 2 or within the at least one of the domains 30, 31, 32 of the subject sgpixel 2 or, as will be seen later, within the at least one dividing line 3 of the subject sgpixel 2 comprises:
A brightness gradient 4, and/or
One or more gradients 4 corresponding respectively to one or more color(s) and/or shade(s).

Each gradient 4 among the at least one gradient 4 within the subject sgpixel 2 or the at least one of the domains 30, 31, 32 of the subject sgpixel 2 or the at least one dividing line 3 of the subject sgpixel 2 is coded by:
two spatial components, preferably in the X and Y directions, to define the direction and modulus of the gradient 4 vector, or
A single spatial component (corresponding to the norm of the gradient vector 4) defined (preferably perpendicular to a dividing line 3 by default, to avoid having to memorize this data) in relation to the at least one dividing line 3 within the sgpixel 2 in question. This dividing line 3 thus makes it possible to define the direction of the gradient vector 4, considering for example always by default that the gradient vector 4 is always perpendicular to this line 3, which by default is a straight line.

The spatial gradient 4 can thus be represented:
according to 2 coordinates X and Y, or
just by a value (preferably signed), its angle being by definition perpendicular to the divide 3 (even if inactive), that is, a spatial gradient 4 along a single coordinate.

The gradient 4 can be applied:
to all (color) components at once, that is, a combination of them, which can be likened to a notion of brightness, for example, or
differently to components with different color or shade, which gives more data to be used than a single gradient vector (with 2 coordinates): 4 or 6 X Y coordinates for each color, or 2 or 3 amplitude coordinates signed by variation, if the angle is known from divide 3 (active or not).

The notion of spatial gradient 4 (first derivative(s)) can be supplemented by one or more terms of higher order than one (second derivatives, third derivatives, etc.), in order to better connect brightness and/or color and/or shade slope jumps between sgpixels 2.

### Implementation of the Divide Property 3

Each divide 3 is a segment-type object, or even a curved line, placed according to a set of parameters on the sgpixel 2 in question, separating it into several distinct domains 30. In particular, each domain 30 can have its own definition of color(s) and/or shade(s) and/or brightness, independent of the other domain(s) of the same sgpixel 2 in question.

Potentially, there may be a multiple (more than one) divides 3 per sgpixel 2, that is, more than two domains 30 per sgpixel 2.

As explained previously, in the case of a divide 3 which is a segment, this divide 3 defines its relative position in the sgpixel 2 either by the position of 2 points A (referenced 51) and B (referenced 52) on the contours 53 of the sgpixel 2 or by the knowledge of a distance 61 to the center of the sgpixel 2 and an angle 62 (polar coordinates).

Each divide 3 of a sgpixel 2 divides this sgpixel 2 into at least two domains 30 (for example, for two intersecting divides 3, each divide 3 will have two domains 30 on each of its sides, that is, 4 domains in all within a sgpixel 2) and:
each domain 30, 31, 32 has a set of properties of color(s), shade(s), brightness, and spatial variation(s) 4 if such variation 4 is implemented), or
at least one domain 30, 31 is described by its own set of color(s), shade(s), brightness and/or gradient(s) 4 properties, the at least one other domain 30, 32 inherits color(s), shade(s), brightness and/or gradient(s) 4 from neighboring pixels or sgpixel(s). This solution is preferable to defining a set of color(s), shade(s), brightness and/or gradient(s) 4 for each domain 30, 31, 32 in the sgpixel 2 itself. Indeed, the memory footprint for describing the image is reduced accordingly, and the inheritance of color(s), shade(s), brightness and/or gradient(s) 4 from neighboring pixels or sgpixels naturally creates an extension of color(s), shade(s), brightness and/or gradient(s) 4 in continuity with these sgpixels 2. The disadvantages being that a few rules should be established on how to read neighboring pixels or sgpixels, and if need be information should be mixed from multiple contiguous or nearby pixels or sgpixels with each other and with respect to the region of the sgpixel 2 to which color(s), shade(s), brightness and/or gradient(s) 4 properties are to be inherited as described in a little more detail later on.

As shown in FIGS. 2 and 3, each dividing line 3 has a visualizable state with a visualization area (corresponding, for example, to the product of the length and the width of the line used to visualize this dividing line 3) with its own brightness and/or color(s) and/or shade(s).

Viewable means a state of the dividing line 3 for which this line 3 is or will be displayed and viewed with its viewing area when it is (if a display is in progress) or will be (if a display is not in progress) displayed on a screen.

This viewing area is measured in arbitrary units, for example defined in relation to the area of the pixel 2 comprising this dividing line 3.

Furthermore, the at least one dividing line 3 can itself feature a spatial gradient enabling its brightness and/or color(s) and/or shade(s) to be modulated when it can be viewed or visualized.

In method 1, the at least one dividing line 3 can be switched between its viewable or visible state (with its viewing area) and a non-viewable or invisible state.

In this way, each divide 3 can be made visible or invisible.

If a divide 3 is made visible, it is assigned a set of thickness or width and length or viewing area, and optionally a set of color(s) and/or shade(s) and/or brightness, and/or spatial variation(s) 4 of color(s) and/or shade(s) and/or brightness, with some or all of these properties specific to that divide, and/or some or all of these properties defined globally for all divides 3 of all sgpixels in the image.

In the case where a divide 3 is made invisible, it no longer has a viewing area (but is still coded and recorded by the method 1, in particular for its position within its sgpixel 2, but under an “invisible” status or state)

The at least one dividing line 3 can be switched between an active state and an inactive state. In this way, each divide 3 can be active or inactive. When it is inactive (and still coded and recorded by the method 1, notably for its position within its sgpixel 2, but under an “inactive” status or state) and it is the only divide 3 of a sgpixel 2, this sgpixel 2 is considered as a single domain, in particular for uniformly applying its color(s), shade(s), and/or brightness information and/or its gradient(s) 4 (if used and not zero) of color(s), shade(s), and/or brightness. If divide 3 is inactive and the variability 4 of color(s), shade(s) and/or brightness is zero, the visual rendering of a ‘conventional’ pixel from the prior art is restored, even though the method 1 will be quite distinct from the prior art due to the specific coding or recording of these zero values.

In this way, each dividing line 3 can have a state:
Active and viewable or visualized: it is active, that is, it marks a divide between multiple domains 30, and can be seen with its viewing area
Active and non-viewable or non-viewed: it is active, that is, it marks a divide between a plurality of domains 30, but it cannot be seen, that is, this line 3 is a line with a straight or curvilinear length but has zero thickness or width,
Non-active and non-viewable or non-viewed: it is not active, that is, it does not mark a divide between multiple domains 30, and but it cannot be seen, that is, this line 3 is a line with a straight or curvilinear length but has zero thickness or width.
Non-active and viewable or visualized: it is not active, that is, it does not mark a divide between a plurality of domains 30, but it can be seen with its viewing area.

Typically, the method comprises deactivating the at least one dividing line 3 of the subject sgpixel 2 if this subject sgpixel 2 is sampled below a certain spatial sampling threshold, to avoid erroneous interpretation of zones that are too lightly sampled. This makes it possible to read text at the sampling limit, but avoids the risk of no longer recognizing what is written if you zoom in. In fact, keeping the divides 3 activated could mean wrongly deciding on the meaning of pixels, which it may then be more prudent not to do in order not to encode false information in the image.

Visibility and activation of a divide 3 can therefore be independent, for example:
inactive divide 3 (so color(s), shade(s), brightness(es), gradient(s) 4 identical on either side of divide 3), but
visibility of the active divide to represent a thread, a hair, a very fine object . . . superimposed on the background colors of the sgpixel 2.

A partial transparency property can also be added to the visibility of the at least one dividing line 3.

Rule(s) for Inheriting from Neighboring Pixels or Sgpixels 2

Preferably for at least one or each subject sgpixel 2:
at least one brightness and/or color and/or shade within the subject sgpixel 2 or at least one of the domains 30, 31, 32 of the subject sgpixel 2 depends on a brightness and/or color and/or shade of at least one neighboring pixel (which may also be a sgpixel) of the subject sgpixel 2 or at least one domain 30, 31, 32 of a neighboring pixel (which may also be a sgpixel) of the subject sgpixel 2, and/or
at least one brightness and/or color and/or shade gradient 4 within the subject sgpixel 2 or at least one of the domains 30, 31, 32 of the subject sgpixel 2 depends on a gradient 4 of brightness and/or color and/or shade of at least one neighboring pixel (which may also be a sgpixel) of the subject sgpixel 2 or at least one domain 30, 31, 32 of a neighboring pixel (which may also be a sgpixel) of the subject sgpixel 2.

Typically, the color(s), shade(s) and/or brightness component(s) and/or the gradient(s) 4 thereof of the neighboring sgpixel are spatially extended to obtain the color(s), shade(s) and/or brightness component(s) and/or the gradient(s) 4 thereof (if variability 4 is implemented in the method 1) of the domain 30, 32 not defined as its own.

Depending on the angles 62 of the at least one divide 3 of the sgpixel 2 inheriting at least one component, there may be inheritance from one or more neighboring pixels with averaging or weighted averaging from the neighboring pixels.

Example 1: In the case of a vertical divide 3 (90° angle) which defines a right-hand side, the method 1 takes into account the colors of the sgpixel on the right (or EAST) for domain 32 (taking into account at least one variability 4).

Example 2: In the case of an oblique divide 3 at an angle of 135°, the method 1 takes into account the neighboring pixel in the Northeast position for domain 32.

Example 3: In the case of an oblique divide 3 at an angle between 90° and 135°, the method 1 prorates the weighting between its 2 East and Northeast sgpixels, based on the angular deviation, which is written as follows:

C_{c}(i)=((135°−α)*Prol(C_{E}(i))+(α−90°*)Prol(C_{NE}(i)))/(135°-90°)

Where:
α is the angle of the divide (0° being the horizontal, with inheritance then taking place below with the neighboring pixel SOUTH, 180° also being the horizontal with inheritance with the neighboring pixel North above, which translates the fact that segment 3 is oriented and which defines the specific domain 31 and the domain 32 inherited).
C_{c}(i) are the color values i=1 to 3 (for respectively 1 for R (Red), 2 for G (Green), 3 for B (Blue)) of the subject sgpixel 2 in the center.

Index c is for sgsgpixel 2 ‘in the center’, whose domain 32 inherits from its neighbors,
C_{E}(i) for the sgpixel to the East (or right) are the color values i=1 to 3 (for respectively 1 for R (for Red), 2 for G (for Green), 3 for B (for Blue)) of the neighboring sgpixel to the right of the subject sgpixel 2 in the center,
C_{NE} (i) for the sgpixel to the Northeast (or right) are the color values i=1 to 3 (for respectively 1 for R (for Red), 2 for G (for Green), 3 for B (for Blue)) of the neighboring sgpixel to the top-right of the subject sgpixel 2 in the center,
Prol( ) is the extension operator that takes into account the spatial variability 4 defined in the sgpixel argument, towards the place of inheritance.

This rule can be expressed in a similar way for the alpha angle varying from 0 to 360°, by invoking the various sgpixels at the cardinal points South, Southeast, East, Northeast, North, Northwest, West, Southwest.

This provides a non-limiting example of a rule providing color continuity between the inheriting part of the sgpixel and its neighbor(s). Other methods are also possible, for example involving more than 1 or 2 neighboring sgpixels in the rules defined above.

### Property or Component Coding

In the method 1 just described, the properties encoded and recorded by the method 1 of at least one or each sgpixel 2 thus comprise:
The components (also called channels) of the sgpixel, 2 which include:
   color(s), shade(s), and/or brightness of the sgpixel 2, and/or
   color(s), shade(s), and/or brightness of each domain 30 (preferably distinct for each domain 30) within the sgpixel 2, and/or
   color(s), shade(s), and/or brightness of each divide 3 (preferably distinct for each divide 3) within the sgpixel 2, and/or
   color(s), shade(s), and/or brightness gradient(s) of the sgpixel 2, and/or
   color(s), shade(s), and/or brightness gradient(s) of each domain 30 (preferably distinct for each domain 30) within the sgpixel 2, and/or
   color(s), shade(s), and/or brightness gradient(s) of each divide 3 (preferably distinct for each divide 3) within the sgpixel 2
active or inactive state of each divide 3 (preferably distinct for each divide 3) within the sgpixel 2, and/or
viewed or unviewed state (or viewable or unviewable state) of each divide 3 (preferably distinct for divide 3) within the sgpixel 2, and/or
position of each divide 3 (whose orientation may define a domain 31 of color(s), and/or brightness and/or shade properties defined by those of the pixel and/or gradients, and a zone 32 inheriting properties from neighboring pixels) within the sgpixel 2, and/or
viewing area or width of each divide 3 (preferably distinct for divide 3) within the sgpixel 2.

In the method 1, any of the components or properties described above (that is, at least one of these components or properties, in whole or in part):
can be defined by a set of digital information specific to each sgpixel 2, or
in order to reduce memory usage, can be obtained by reference via sgpixel's 2 own code addressing an external table. This external table implements a dictionary of property or component values, in order to obtain a broader, customizable description, without significantly increasing the memory usage at the level of the sgpixel 2.

By way of example, this table-based implementation pointed from an index in sgpixel 2 will be useful if we assume that the ‘visibility’ property is only rarely activated in an image. For example, visibility will be activated to render the presence of hair on a person, or the presence of fine threads emanating from a fabric. As these elements are rarely present, and generally have a rather homogeneous color, or a similar width but variable color, one may choose not to endow sgpixels 2 with all the properties specific to these divides, properties such as color, color gradient along the sgpixel, separator width. For example, we'll choose to represent the brightness of the divides visible in each sgpixel, on the assumption that it can vary greatly over the image, but the shade, saturation (color) and width will be defined in a table with few elements, on the assumption that these elements vary little, or include a non-obtrusive quantization, for example 15 entries maximum. Thus, for example, each sgpixel 2 has a 4-bit integer (that is, 24=16 values) as a divide visibility activation code, value 0 being invisibility, values 1 to 15 pointing into said previously described table. The brightness of these objects can be coded on 4 to 8 other bits (that is, 16 to 256 values), or not, and this information can also be placed in the aforementioned table.

In another example of representing the position of the divide 3 in sgpixel 2, conversely, again by way of example, let us assume that the position property of the divide 3 is often activated, or else according to a variety of angles and positions that would make a large number of combinations. Thus, for example, the two points of the divide segment 3 in contact with the contour of sgpixel 2 are represented by two one-byte numbers (that is, 256 values). It is possible to keep one of the values of these two numbers to make the divide 3 inactive. Rather than encoding these elements in a table, which would have as many entries as these two bytes, and which would not save any memory space, having a two-byte table addressing code, and 2 bytes in the table, to be compared with the only two bytes of the property itself in sgpixel 2.

### Transcription

When displaying an image obtained by the method 1, the information coded by this method should be converted into the values of the photoemitters 71, 72, 73 that generate the image (recorded by the method 1) on a screen, which amounts to pixelating (or rasterizing) the image according to the pitch of the display screen.

For example, the method 1 may comprise converting an initial image into a final image for:
a display 13 of the initial image into the so-called final image on a screen comprising groups 7 of photogenerators 71, 72, 73 (each group 7 comprising, for example, three photogenerators R referenced 71, G referenced 72 and B referenced 73), or
pixelation 13 or rasterization 13 of said initial image into a final image comprising final pixels 7 devoid of dividing lines and/or spatial gradients of color(s) and/or shade(s) and/or brightness within these final pixels 7 (that is, no final pixel 7 is a sgpixel), said initial image being recorded according to the invention with at least one sgpixel 2 as described above.

The reference 7 is used for each final pixel 7 or for each group 7 of photogenerators, particularly in FIG. 2, as the transcription principle is the same.

Each initial pixel can be a sgpixel 2, with the initial pixels comprising at least one, preferably more than one, sgpixel(s) 2. Preferably, each initial pixel will be considered a sgpixel 2.

Thus, the method 1 comprises:
For each final subject pixel 7 or each subject group 7 of photogenerators 71, 72, 73, a transcription 13 of at least one initial pixel 2 or at least one initial pixel 2 domain 30 into this subject final pixel 7 or subject group 7 of photogenerators:
   from the brightness and/or color and/or shade components of this at least one initial pixel 2 or at least one initial pixel domain 30
   to this subject final pixel 7 or subject group 7 of photogenerators 71, 72, 73,
      the transcription being made in proportion to this at least one initial pixel or at least one initial pixel 2 domain 2 within a facing common surface between:
this at least one initial pixel or at least one initial pixel domain 30 and
the subject final pixel 7 or subject group 7 of photogenerators.

In the present description, two parts of the initial image on the one hand and the final image on the other hand are considered to face each other or to be facing each other if they are superimposed in a common representation of the initial image on the one hand and the final image on the other hand in a common conversion reference frame showing the conversion or transcription of the initial image to the final image.

For transcription purposes, if the subject final pixel 7 or subject group 7 of photogenerators is facing different initial pixel(s) and/or domain(s) 30 of initial pixel(s) and/or divide(s) 3 of initial pixel(s), the brightness and/or color(s) and/or shade(s) components of the subject final pixel 7 or of the subject photogenerator group 7 are a prorated weighted average of the respective areas of these different initial pixel(s) and/or initial pixel domain(s) 30 and/or initial pixel divide(s) 3 with respect to the subject final pixel 7 or subject photogenerator group 7.

For example, for the calculation of surface area prorata, in addition to FIGS. 2 and 3, which show special cases that will be described later, let Pᵢ be the initial pixels, and Pᵢ(k) an initial pixel with index k.

Let P_{f} be the final pixels, and P_{f}(r) a final pixel of index r.

Col(Pi(k), d, c) is a color component value,
where c is the color index, for example 1 . . . 3,
d the domain index, e.g. 1 . . . 2 for each side of the divide 3. The value 3 is added if the divide is visible, to describe this new domain, described by the axis of the dividing line 3, thickened by half its width on each side. This thickening can be deducted from the surface area of adjacent domains 31, 32.

S(P_{f}(r), Pᵢ, k, d, [symbol] ) is the common facing surface (hence the intersection symbol) between the initial pixel (sgpixel) index k, domain d, and the final pixel (f for final).

S_{f}(P_{f}(r)) is the total area of the final pixel, also denoted S_{f} if all final pixels have identical areas.

The color contribution for the final pixel r, derived from the initial pixel k, is:

$$Col ( {P}_{f} ( r ) , c ) = \frac{{\sum }_{k} {\text{?}}_{[ K ( r ) ] , d} {\text{?}}_{( D ( k ) )} Col ( {P}_{i} ( k ) , d , c ) \cdot S ( {P}_{f} ( r ) , {P}_{i} , k , d , \text{?} )}{{S}_{t} ( {P}_{f} ( r ) )}$$

$$\text{?} \text{indicates text missing or illegible when filed}$$

where:

K(r) is the set of indexes k for index r for which there is a match.

D(k) is the set of domain(s) of pixel k (previously chosen from K(r))

which is to be understood as: on the left, the color component c, for the final pixel of index r (r can also be written as a function of two indices, ixr and iyr, that describe the two dimensions, for example concatenated in a table described by index r) is equal to the sum over all indices k of initial pixels, facing the pixel r, all the domains d of this pixel k—concerned by the intersection, or all the domains, with the ones taken in excess being assigned a zero area, and thus naturally disappearing from the sum—of the color component c, times the common area facing (hence the symbol intersection), the sum divided by the total area of the restored pixel. The domain d can take on the values 1 and/or 2 depending on the side or domain 31, 32 of the (sg)pixel 2 in question, if there is only one active divide 3. If the divide 3 is inactive, only one domain d=1 occupies the entire sgpixel, unless divide 3 is visible, see below.

In the case where the divide 3 is made visible, a new domain d=3 is defined. The area calculation can be explained as the product of the length Lₛₑₚ of the divide 3 of the initial pixel sgpixel 2 which faces the final pixel 7 (also called restored pixel), times the width W of the divide 3 of this initial pixel k (which can be preferentially defined as a property for each initial pixel k, or global to use less memory space), which is written:

S(P_{f}(r),Pᵢ,k,d, [symbol] )=Lₛₑₚ(P_{f}(r),Pᵢ(k), [symbol] )W(k)

For transcription purposes, the brightness and/or color(s) and/or shade(s) components of an initial pixel and/or initial pixel domain 30 and/or initial pixel divide 3 are modulated by the gradient(s) 4 values of each initial pixel part and/or initial pixel domain 30 and/or initial pixel divide 3 with respect to the subject final pixel 7 or subject photogenerator group 7.

For example, for the prorata calculation of areas with gradients 4, we have:

$$Col ( {P}_{f} ( r ) , c ) = \frac{{\sum }_{k ∈ [ K ( r ) ] , dϵ ( D ( k ) )} \int {\int }_{\overline{M} ϵS ( {P}_{f} ( r ) , {P}_{i} , k ,} \text{?} Col ( {P}_{i} ( k ) , d , c , \overline{CM} ) , ds}{{S}_{t} ( {P}_{f} ( r ) )}$$

$$\text{?} \text{indicates text missing or illegible when filed}$$

where a vector (that is, with 2 coordinates) is added to Col, to take into account that Col is modified by gradient 4, inside the sgpixel. The sum is found across all points \vec{M} belonging to the intersecting surface.

The dependence of color on position M in the initial pixel can be written as:

$$Col ( {P}_{i} ( k ) , d , c , \overline{CM} ) = Col ( {P}_{i} ( k ) , d , c ) + \overline{∇} ( {P}_{i} ( k ) , d , c ) , \overline{CM}$$

where \vec{∇}(P_{f}(k), d, c) is the value of the gradient 4 of all components at once, —which is then written as \vec{∇}(P_{f}(k),d)− or a potentially different gradient for each component c. A scalar product, denoted ‘.’, is formed between this gradient and the displacement vector \vec{CM}, where C is the color reference point Col(Pi(k), d, c), and M is the point describing the initial pixel. This point C is, for example, the center of the initial pixel, or a corner.

Depending on the representations chosen, c can take on three values, 1 to 3, for example, with Col( ) representing the color values Red, Green, Blue. Or, in a YUV system, with Y for relative luminance and U and V for chrominance, and:

Y≃R+G+B

U≃B−Y

V≃R−Y

then Col(1) can represent brightness, Col(2) the U component, Col(3) the V component. Of course, other types of representation are also possible, such as HSL (Hue Saturation Lightness).

A dividing line 3 of an initial pixel can be used to be viewed and contribute to the brightnesses and/or colors and/or shades of at least one subject final pixel 7 or subject group of photogenerators 7, in proportion to all or part of the viewing area of the dividing line 3, which is facing the subject final pixel 7 or subject group of photogenerators 7.

In the preferred and shown case of a straight dividing line 3, this viewing area is obtained from the product of a width property of the dividing line 3 times the length of said dividing line 3.

The viewing area of the dividing line 3 separating different domains 30 correspondingly reduces the area taken into account of the adjacent domain(s) 30 of the initial sgpixel 2 for the other area prorata.

For example, with reference to FIGS. 2 and 3, for pixelation (or rasterization) for displaying the initial image on a screen:
If the pixel density of the initial sgpixel image is such that an initial pixel faces a photogenerator group 7 R, G, B of the screen, the method 1 calculates the average value over each color component of the screen, in proportion to the area of each color of each domain 30 of the initial sgpixel 2 of the initial image, possibly supplemented in proportion to the viewing area of the divide 3 (its width×its length) times its color components, respectively.
If this 1:1 ratio is not obtained, a proportion of the relative surface area occupied by the photogenerator 71, 72 or 73 (surface area reduced to the total surface area of the replication step) should be considered, and the properties of the domains 30 of the initial pixels superimposed on this surface area should be averaged. In this way, the average values of light transmitted or generated by the screen will be spatially as close as possible to the information represented locally in each domain 30 of the initial sgpixels 2, for greater fidelity of image representation by the screen.

This type of rule does not prevent the more general application of gamma corrections (linearity), or color conversion between the initial sgpixel image and its materialization on screen.

Of course, in the event of enlargement, only part of the initial sgpixel image can be represented, based on the same correspondence rules applied to pixels in or straddling the zone of the screen.

FIGS. 2 and 3 show how to apply this type of rule, with a variant depending on whether you limit yourself to considering the final pixel 7 or group 7 for its overall size R+G+B as indivisible, or instead split it into 3 distinct entities 71, 72, 73 present in their respective and different positions.

With reference to FIG. 2, for a pixelization (or rasterization) for conversion to a conventional bitmap format image with final pixels without sgpixels, method 1 proceeds with the same correspondence rules as those shown for materializing the initial sgpixel image to a screen, if it is to be converted to a conventional raster-format object of the prior art.

FIG. 2 shows the conversion of an initial image of sgpixels 2 recorded using the method 1 according to the invention and to be converted into a final image to a 4×4 matrix of final pixels 7 or groups 7 of photogenerators 7 (solid squares) of a display showing the image of sgpixels 2.

Among the sgpixels 2 of the initial image, three sgpixels referenced SGA, SGB and SBC can be seen in succession along a line of sgpixels.

It is assumed that each final pixel 7 is capable of rendering a Red (R), Green (G), Blue (B) color by switching on emitters 71, 72, 73 in proportion to the R, G, B values of these final pixels.

The sgpixel 2 in the center is a so-called SGB sgpixel. For this SGB, the dividing line 3 is the active, visible SGB sgpixel (e.g. green in color, with the width directly represented by that of the line) dividing SGB into two domains 31 and 32. Other sgpixels 2 are shown in thinner lines around them.

A final pixel is called by its row and column number in this way: (row number of the final pixel matrix, column number of the final pixel matrix)

Note that because of its total overlap with SGB, the final pixel row 2, column 3 (final pixel (2, 3)) receives its colors solely from the sgpixel SGB.

Let us assume that the domain 31 of the SGB sgpixel (called sg B-1) is 100% red (the G and B at 0%).

Let us assume that the domain 32 of the SGB sgpixel (called sg B-2) is 100% blue (and 0% R and G). The line 3 of the SGB is assumed to be 100% green (and 0% R and B).

Let's assume that SGB trait 3 represents 5% of the SGB surface area, sg domain B-1 65%, sg domain B-2 30%.

Then the final pixel (2, 3) receives the values R, G, B at:

R=100%*65%=65%

G=100%*5%=5%

B=100%*30%=30%

Let us assume the sgpixel SGA is 100% Red only (no divide, no other color).

The final pixel (2, 2) then receives:
R=100% (mixture of the SGA and SGB parts in proportion to their respective surface areas, in this case 100% red). G and B are at 0%

The final pixel (2, 1) also receives R=100%, G and B=0% directly from SGA.

Let's assume that the SGC sgpixel is 95% blue (its other components at 0%).

Then the final pixel (2, 4) receives R=0%, G=0%, V=15%*100%+85%*95%=95.75% (as it is assumed to have 15% overlap with SGB, 85% with SGC).

These numerical examples reflect a possible area proportion rule for rendering the final pixel intensities to be displayed from the sgpixel 2 image information.

Note that the line 3 is rendered here by blending, as the screen resolution does not allow for anything better. On the contrary, if the final pixels of the screen are extremely fine, which happens when the initial image of sgpixels 2 is enlarged around the SGA, SGB, SGC pattern, then the green-colored line 3 may correspond to a very green pixel below this green line with a little Red and Blue from neighboring sg B-1 and sg B-2. Zooming in even further, the line 3 can be represented by an oblique row of completely green final pixels.

By way of illustration, the SGE sgpixel below the SGB sgpixel is shown with its divide 3 active, but in a less saturated color (green, for example), with a more vertical angle, connecting continuously with the one above (this continuity is not obligatory, but can be quite frequent if the two visible divides represent a real element such as a hair). The width of the SGE divide 3 is assumed to be reduced.

Note that we have significantly changed the color of the SGB between sg B-1 and sg B-2, and made divide 3 visible, in order to show the area proportion rule, but in the majority of cases, on a natural image, it is often the case that if the visibility of a line 3 is active, the domains 30 will remain the same color, as a fine object, such as a hair on a face, rarely corresponds to a change in background color (e.g. the skin under the hair). So the example here would be that of an artificial drawing with materialized contours.

Spatial variability 4 has not been activated to simplify the description here. It could have been used on divides 3 to connect the two without any visible jump from lightly saturated to highly saturated green (which would demonstrate the quality of the rendering at very high magnification). It could have been between SGB part sg B-2 and SGC to take account of the transition from 100% to 95% on the Blue. Note also that one may assume SGC with a blue gradient increasing towards the left, to 95% in the center, which can make an inheritance for the sgB-2 part taking on a value of 100% thanks to this SGC gradient that enhances the blue from SGC, according to the Prol( ) extension operation previously mentioned. SgB-2 also inherits this gradient.

FIG. 3 shows a variant of conversion from sgpixels 2, which takes into account the exact position of the red (R, referenced 71, and all hatched obliquely), green (G, referenced 72, and all hatched horizontally), and blue (B, referenced 73, and all hatched vertically) generators (also called emitters or photogenerators) in each final pixel 7 of the screen. This rasterization is potentially more accurate in terms of rendering, but requires knowledge of the shape details of the screen, which may not be the case, and makes the method shown in FIG. 2 preferable.

FIG. 3 is therefore a similar representation to FIG. 2, shown with the same sgpixel values SGA, SGB, SGC, etc. The R, G, B emitters of the final pixels are shown. The area ratio rules are applied taking into account the color of each pixel emitter overlapping with the sgpixels 2.

So, as the R of the final pixel (2, 3) is not completely in sg B-1 but predominantly, it will receive its value here at 95% and not 65%, (assuming that the green SGB divide 3 and the sg B-2 domain represent 5% of the area facing the Red emitter of the final pixel (2, 3)). Similarly, the green of the final pixel (2, 4) will receive B=95% because it is completely under the sgpixel SGC Blue at 95% (and not B=95.75% as in FIG. 2).

### Compression or Decompression

The method 1 may further comprise a step for compressing or decompressing an initial image recorded according to the previously described method (and therefore comprising one or more sgpixel(s) 2): the initial image is respectively compressed or decompressed into a respectively compressed or decompressed image by respectively decreasing the volume of information representing the compressed image through compression or increasing the volume of information representing the decompressed image through decompression, the compression or decompression relating to at least one previously listed sgpixel 2 component or property, preferably among the color(s) and/or shade(s) and/or brightness (of sgpixel 2, domain 30, and/or divide 3) and/or the at least one dividing line and/or the at least one spatial gradient (of color(s), shade(s) and/or brightness for each sgpixel 2, domain 30, and/or divide 3) within each subject initial pixel.

The initial image is respectively compressed or decompressed so that its content can be viewed directly using a method based on the viewing or display steps described above, without any additional step of transcribing the final image.

For the decompressed image, the divide property 3 or gradient property 4 can be used ‘directly’, as shown in FIGS. 3 and 4.

Whereas in the case of a compressed image, for example by wavelet, the divide 3 or gradient 4 value is not directly available for each sgpixel, as it is obtained as a frequency component applying to a plurality of pixels.

Typically, the initial image is compressed or decompressed, respectively, using:
a wavelet transformation of each component to be compressed, and/or
a Discrete Cosine Transform (DCT).

After compression or decompression, the method 1 may comprise a search for identical sequences, indexing these sequences and replacing each repeated sequence by its index in a stream of image data or information.

Preferably, the method 1 uses lossy compression on at least one component among color(s) and/or shade(s) and/or brightness and/or at least one dividing line and/or at least one spatial gradient of each subject initial pixel or of the at least one divide within each subject initial pixel, and lossless on at least one other component (a more critical one) among activation or deactivation of the at least one divide 3, and/or visualization of the at least one divide 3 and/or width or viewing surface of the at least one divide 3.

Generally speaking, compression involves considering divide information, spatial gradient and, if applied, divide widths, colors and gradient 4 (Alpha being the transparency channel, if available) as additional channels to spatial information such as R, G, B and Alpha.

Of course, for the object or file containing the image recorded according to the invention and compressed, a global description field may be desirable to define the use or non-use of this or that element among divide, spatial variation, divide visualization properties, or any other method making it possible to know whether these elements are part of the compressed image object. It is possible to consider only the divide and the spatial variation, without the visibility of the divides, which eliminates the need for the color, width, and gradient channels of the divides.

Except in special cases, positions/angles for inactivated divides 3 can preferably be filled with a single value that is homogeneous throughout the image, so as not to create false information that would hinder compression and add unnecessary spatial frequencies to the image to be compressed, and the same applies to other unused channels.

Generally speaking, the compression techniques known for the R, G, B, Alpha channels can be applied to these additional channels, that is, the divide 3 and the spatial variation 4, the divide 3 visibility info, the divide 3 activation info, and so on.

To that end, here are a few compression techniques. In the prior art, image compression is generally achieved by transforming sub-blocks of the image, by projecting said block onto DCT (Discrete Cosine Transformation) bases, or by wavelet compression. The sequence produced by concatenating these coefficients of projection on these bases and the various pixels is optionally further compressed using LZ77 or LZ78 compression or equivalent (LZ77 consists schematically in locating and indexing sequences identical in position and length rather than repeating and writing them explicitly, see https://fr.wikipedia.org/wiki/LZ77_et_LZ78). Entropic compression is also known, where frequent symbols are replaced by shorter ones.

LZ77 compression can also be applied directly to the original image without DCT or wavelet compression.

The person skilled in the art will be able to refer to the descriptions of the JPEG 2000, JPEG XR, JPEG XL and PNG compression formats, among others, for the implementation of these types of compression.

These transformations can be lossless or lossy. When lossy compression is used, high-frequency components can be modified by thresholding, for example: if the amplitude of these components is too low, they can be reduced to zero so that they can be ignored (or further compressed). Similarly, the resulting coefficients can be quantized, that is, the binary low-weights can be deliberately rounded off to 0 and these bits removed, thus reducing the number of bits in the coefficients derived, for example, from DCT or wavelet transforms, or directly from the initial image, resulting in fewer bits to be transmitted, or producing more identical sequences in an additional LZ77 compression.

For the method 1 according to the invention, where compression is to be applied to the image produced, in the case of lossy compression, it is highly preferable to separate each coordinate of each piece of information (divide, spatial variation, and optionally the visibility of divides, etc.) into channels that will be compressed independently.

Indeed, in the case of lossy compression, which can generally lead to the modification of values through the loss of low-order bits (the cancellation to zero of weak high-frequency components can also be likened to this), it is important to ensure that the rounding of values does not excessively affect one of the properties added to the sgpixels 2 by the method 1. For example, for a binary concatenation X:Y into a single pseudo number, the Y value could become significantly false if it undergoes the rounding to 0 of bits considered of lower significance, to a greater extent than the X component, which would be spared such rounding. It is therefore recommended to consider X and Y as 2 different channels, so that rounding values affect X and Y directions in a similar way, for example, and likewise for X and Y, which represent the divide position in sgpixel 2. Similarly, for a polar representation of distance 61 and angle 62, we will preferentially consider this information in 2 different channels, not concatenated in binary form.

If particular position values are used to inactivate the divide 3, with lossy compression, this activity state should be represented by another channel applied to the compression, for example a Boolean field (with 2 values, active/not active), to avoid any loss of this information as a result of rounding coding, unless special precautions are taken in order to be resilient to such loss.

Similarly, if divide 3 visibility is used, via code encoding that points to a table, and this code is presented directly at the compression input (rather than the property values it represents), it is generally advisable to ensure that this code will never be corrupted by compression/decompression, unless special precautions are taken in order to be resilient to such corruption. To better withstand a change in code value, one may arrange information with similar values in table cells with similar indices, so as to obtain a small change in property values from the table when the code, and therefore the table cell, changes.

Of course, in the desirable case of channel compression of these divide visibility representation codes, the pointed table values should preferentially be stored in global fields of the image file or object, so that they can be restored with the decompressed image at a later date (and not assumed to be universally known for all images).

Among the additional channels, if each sgpixel contains 2 or more sets of color properties, for example to define the colors on each side of the divide separately, these should of course also be treated as additional channels to be compressed/then decompressed.

The method 1 may comprise a change of reference point for information on divide 3, spatial variation 4, visibility of divide 3, etc.

Eventually, if the compression allows it due to the absence of jump risks linked to information loss, combinations between divide channels, spatial variation, and/or divide visibility, etc. can be carried out, in particular, but not necessarily, if lossless compression is used. These combinations can use correlations to reduce the amount of information to be compressed.

For example, in the prior art, for R, G, B, we know the Y, U, V reference change, which consists in calculating Y=R+G+B (with possible weightings other than 1, 1, 1 between colors), which provides a luminance channel called Y, and U and V chrominance channels. As the human eye is less sensitive to the spatial frequencies of U and V, than those of Y, high spatial frequency information from these U and V components can be attenuated or suppressed to reduce the information to be compressed, upstream of DCT or wavelet transformation, for example.

In the case of the method 1 according to the invention, such combinations can therefore be made, if necessary, especially to remove information redundancies.

For example, if spatial variation 4 is represented in each sgpixel 2 by two components X, Y, it can be considered to be often perpendicular to the dividing line 3, in the sgpixels 2 where it is active. In this case, one may simply present the amplitude of the spatial variation 4 (preferably signed, as brightness can increase or decrease in the direction of the divide 3), and not its angle, since this is known by that of the divide 3. On decompression, the angle of the gradient 4 is obtained by perpendicularity to the divide 3. Even when inactive, angular information 62 from the divide 3 can be interpreted to orientate the gradient 4 in the XY plane—that is, in sgpixel 2. This eliminates the need for one directional field. The X and Y information of gradient 4 represent the spatial variability of the sgpixel 4 and can be replaced by +/−\sqrt{X²+Y²}.

On decompression, the method 1 restores the various property channels of sgpixels 2, in addition to restoring the color and transparency channels, in order to fill in the properties of all sgpixels 2 in the image. If compression/decompression is lossy, make sure that rounding does not significantly alter the resulting decompressed image. For example, a moderate inaccuracy of spatial variation 4 may be acceptable. But an activation shift from the divide 3 to a neighboring pixel would not necessarily be acceptable. The same applies if an unintentional duplication of the activation of the divide 3 were to occur at pixels adjacent to the one where it is actually active.

The method 1 repeats the decompression operations for each pixel sub-block, if necessary, for several or all of the pixel blocks of the initial image.

The method 1 according to the invention is implemented by a computer program product comprising computer code instructions for executing the method 1.

Generally speaking, each of the steps of the method 1 is implemented solely by technical means, which may for example include at least one computer, a central processing or computing unit, an analog (preferably dedicated) electronic circuit, a digital (preferably dedicated) electronic circuit, and/or a (preferably dedicated) microprocessor, and/or software means, and/or the computer program product described above.

### Example Domains of Application for the Method 1

The method 1 applies in particular to real-world images, that is, photographs or films. However, it can of course also provide its advantages to images derived from synthetic objects, for example derived from the translation of vector image primitives in order, for example, to distribute them on a website in a format that does not require local de-vectorization, while allowing zooming of better quality than was possible when translating these vector images into bitmaps before the method of the invention, as was sometimes the case in the prior art.

Web images don't generally use vectorization as standard, to avoid the risk of potentially variable rendering times depending on the complexity of object stacking or density. The sgpixel format according to the invention, by preserving the notion of matrix, avoids this pitfall, making it possible to use this format for the Web, while guaranteeing pre-controlled restitution times, with the possibility of better enlarging parts of the images.

It is applicable, for example, to a computer or smartphone, to provide image enlargements of better quality than the prior art. To this end, a rasterization software module can translate the enlarged image parts into screen pixels.

Similarly, a plug-in specific to this task can be added to web browser software to render and zoom into an image of a web page according to the method 1.

### Example Images

FIG. 5 shows a prior art raster image with little sampling.

FIG. 6 shows a raster image according to the invention with sgpixels according to the invention, better rendered than that of FIG. 5 thanks to divides 3, gradients 4, and visualizations of divides 3 at certain points in the image.

Of note in FIG. 5:
in 91, the absence of any notion of gradient leads to texture jumps,
in 92, the shadow of the metal object creates jaggedness at the edge of the shadow,
in 93, the very fine object (hair) appears jagged,
in 94 (on the paperclip), the pixelation causes unsightly jumps in texture, due to the very fine luminous zone at the top of the wire.

On FIG. 6 obtained by the sgpixels:
the gradients 4 prevent color jumps in 91, the jagged edge in 92 is no longer perceptible, and the thin object in 93 retains a very linear shape without appearing jagged,
In 92, the pixel divide ensures a clean edge (not jagged) even at low pixel density,
In 93, the visualization of the divide over several pixels reveals this highly linear, non-jagged shape,
In 94, the texture brightness is more even. The very bright area at the top of the wire can be represented by a divide of a certain width,
the edge of the thread becomes sharper owing to the activation of the divide in the pixels straddling the background fabric and the paper clip,
the gradient provides a more even texture between the top of the wire and its edges.

Thus, to summarize the method 1 according to the invention, for an image described by a two-dimensional table of pixels, describing for example a field of colors, for example R, G, B values, the method adds:
divide properties 3, which may or may not be activated in sgpixel 2, defining at least two color domains 30 in each image sgpixel.
spatial variation properties 4, within each sgpixel 2 or domain, of color(s) and/or shade(s) and/or brightness properties.
properties to make said divide 3 visualizable.

The proposed method 1 provides a method for digitally representing an image, and for rendering, recording and transmitting it. It allows the image to be enlarged to view only a part of it, without any noticeable loss of quality due to the visible appearance of spatial discretization.

It preserves an image description based on pixel juxtaposition, rather than vectorization in the sense of the prior art. The recommended density of these (sg) pixels can remain moderate, for example equal to that of the sensors used to produce the image. It applies to photographs (single images) or films (sequential images). In particular, it is not necessary to increase the density of these sgpixels, which the prior art would require for equivalent perceived quality, in order to obtain a quality compatible with possible enlargements.

Retaining the notion of pixel juxtaposition facilitates compression/decompression and display processing. Indeed, whereas the prior art may require the conversion of large surface objects before processing (such as display) can take place, the method 1 enables display algorithms to be parallelized more easily, as the actions remain more local, as with the ‘bitmaps’ of the prior art.

The quality of the rendering of multiple details in textures is far superior to what is intrinsically possible with the vectorized formats of the prior art. This is due to the fact that, for multiple gradations in an object's contour, a vectorized object doesn't allow for a fine description, whereas sgpixels 2 does, while retaining the sharp contours that the vectorized format allows.

In the sense of reducing the pixel density of the image, the method 1 enables the selection of a sgpixel density below that of the image sensor, or of the digitization grid, while maintaining good image quality and encoding in the image a significant part of the resolution provided by the photosite density of the sensor, via the properties of the sgpixels. This already achieves a form of image compression compared to the prior art. A method for compressing/decompressing the image from the method 1 is also described, so that it can be transmitted and stored at lower cost.

The sgpixel compression method enables compression ratios similar to those of prior art compression techniques. A compressed sgpixel image is therefore more advantageous than a prior art image thanks to its better quality.

This method 1 applies in particular to real-world images, that is, photographs or films. However, it can of course also provide its advantages to images derived from synthetic objects, for example derived from the translation of vector image primitives in order, for example, to distribute them on a website in a format that does not require local de-vectorization, while allowing zooming of better quality than was possible when translating these vector images into bitmaps before the method 1 of the invention, as was sometimes the case in the prior art.

At equivalent matrix density compared with the prior art, the details are finer in the method 1 according to the invention. Thus, by reducing the density of the sgpixel matrix, the method has less data in total. For example, for:
⅕^{th} of the number of X sgpixels in the method 1 compared with the number of X pixels in the prior art,
⅕^{th} of the number of Y pixels in the method 1 compared with the number of Y pixels in the prior art, that is, 25 times fewer pixels, but:
2 to 3 times more information per sgpixel than per pixel, giving a ratio of 2/25 to 3/25, which means that the image of the method 1 with sgpixels is inherently compressed compared with its equivalent pixel quality in the prior art.

Starting from this example image with 25 times fewer sgpixels, one may still achieve better definition in the method 1 by zooming in. This can be demonstrated if one imagines zooming in on hair or fabric texture, for example: hair remains hair at all zoom levels, whereas it becomes a juxtaposition of pixels in a conventional raster image.

Compared with vectorization, the method 1 requires a processing time for these sgpixel images of the same order as the raster image, whereas this time and quantity of calculations can be much greater for vectorization.

In addition to the natural compression effect of the method 1 as demonstrated above, this sgpixel format supports compression techniques such as wavelet compression and the removal of redundant patterns, which are simply referenced, further reducing data size at equivalent quality compared to the conventional raster equivalent.

Last but not least, method 1 renders the natural complexity of photographic images with many fewer “flattening” effects than vectorization, or to put it another way, with all the finesse and, above all, even better than raster images.

The method 1 is better able to cope with enlargement than a prior-art raster image, especially for a writing image.

Within the scope of the present description, it is also proposed according to the invention, with reference to the processes described in the present description:
a device according to the invention, implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by this device (typically by a lens and/or a sensor of this device), and/or
a use of a method for recording, displaying, pixelating, rasterizing, compressing and/or decompressing according to the invention within a device according to the invention, preferably on an image acquired by this device (typically by a lens and/or a sensor of this device), and/or
a smartphone (also called a multifunction mobile phone), implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by the smartphone (typically by a lens and/or a sensor of the smartphone), and/or
a use of a method for recording, displaying, pixelating, rasterizing, compressing and/or decompressing according to the invention within a smartphone (also called a multifunction mobile phone), preferably on an image acquired by the smartphone (typically by a lens and/or sensor of the smartphone), and/or
a touchscreen tablet, implementing a method for recording, displaying, pixelating, rasterizing, compressing and/or decompressing according to the implement a method for recording, displaying, pixelating, rasterizing, compressing and/or decompressing according to the invention, preferably on an image acquired by this touchscreen tablet (typically by a lens and/or a sensor of this touchscreen tablet), and/or
a use of a method for recording, displaying, pixelating, rasterizing, compressing and/or decompressing according to the invention within a touchscreen tablet according to the invention, preferably on an image acquired by this touchscreen tablet (typically by a lens and/or a sensor of this touchscreen tablet), and/or
a camera (preferably a reflex or bridge or compact camera) implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by this camera (typically by a lens and/or a sensor of this camera),
a use of a method for recording, displaying, pixelating, rasterizing, compressing and/or decompressing according to the invention within a camera (preferably a reflex or bridge or compact camera), preferably an image acquired by the camera (typically by a lens and/or a sensor of the camera), and/or
a vehicle (preferably a motor vehicle, but which may be of any type), implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing, according to the invention, preferably on an image acquired by the vehicle typically equipped with a lens and/or a sensor, this image preferably being used or intended to be used by the vehicle for autonomous driving of the vehicle, and/or
a use of a method for recording, displaying, pixelating, rasterizing, compressing and/or decompressing according to the invention within a vehicle (preferably a motor vehicle, but which may be of any type), to correct an image acquired by the vehicle (typically by a lens and/or a sensor of the vehicle); the image preferably being used or intended to be used by the vehicle for autonomous driving of the vehicle, and/or
a video surveillance system (preferably of a building or geographical area) implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by the video surveillance system (typically by a lens and/or a sensor of the video surveillance system), and/or
a use of a method for recording, displaying, pixelating, rasterizing, compressing and/or decompressing according to the invention within a video surveillance system (preferably of a building and/or a geographical area), preferably on an image acquired by the video surveillance system (typically by a lens and/or a sensor of the video surveillance system), and/or
a drone implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing, according to the invention, preferably on an image acquired by the drone (typically by a lens and/or a sensor of the drone); this image preferably being used or intended or to be used by the drone:
   in the field of agriculture, the image acquired by the drone preferably being an image of plant crops, and/or
   in the field of pollution and/or land use analysis, the image acquired by the drone preferably being a multispectral image, and/or
a use of a method for recording, displaying, pixelating, rasterizing, compressing and/or decompressing according to the invention within a drone, preferably on an image acquired by the drove (typically by a lens and/or a sensor of the drone); this image preferably being used or intended to be used by the drone:
   in the field of agriculture, the image acquired by the drone preferably being an image of plant crops, and/or
   in the field of pollution and/or land use analysis, the image acquired by the drone preferably being a multispectral image, and/or
a satellite implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing, according to the invention, preferably on an image acquired by the satellite (typically by a lens and/or a sensor of the satellite); the image preferably being used or intended or to be used by the satellite:
   in the field of agriculture, the image acquired by the satellite preferably being an image of plant crops, and/or
   in the field of pollution and/or land use analysis, the image acquired by the satellite preferably being a multispectral image, and/or
a use of a method for recording, displaying, pixelating, rasterizing, compressing and/or decompressing according to the invention within a satellite, preferably on an image acquired by the drove (typically by a lens and/or a sensor of the satellite); this image preferably being used or intended to be used by the satellite:
   in the field of agriculture, the image acquired by the satellite preferably being an image of plant crops, and/or
   in the field of pollution and/or land use analysis, the image acquired by the satellite preferably being a multispectral image, and/or
a medical imaging device for imaging the human and/or animal body (preferably by MRI and/or X-ray and/or Gamma-ray and/or ultrasound), implementing a method for recording, displaying, pixelating, rasterizing, compressing and/or decompressing according to the invention and/or comprising technical means arranged and/or programmed to implement a decompressing according to the invention, preferably on an image acquired by the medical imaging device (typically by a lens and/or a sensor of the medical imaging device), and/or
a use of a method for recording, displaying, pixelating, rasterizing, compressing and/or decompressing according to the invention within a medical imaging device for imaging the human and/or animal body (preferably by MRI and/or X-ray and/or Gamma-ray and/or ultrasound), preferably on an image acquired by the medical imaging device (typically by a lens and/or a sensor of the medical imaging device), and/or
a microscope, implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by this microscope (typically by a lens and/or a sensor of this microscope), and/or
a use of a method for recording, displaying, pixelating, rasterizing, compressing and/or decompressing according to the invention within a microscope, preferably an image acquired by the microscope (typically by a lens and/or a sensor of the microscope), and/or
a tomographic imaging apparatus for an image acquired across multiple spectra (preferably in the field of healthcare and/or in the field of industry and/or in the field of agriculture), implementing a method for recording, displaying, pixelating, rasterizing, compressing and/or decompressing according to the invention and/or comprising technical means arranged and/or programmed to implement a method for recording, displaying, pixelating, rasterizing, compressing and/or decompressing according to the invention, preferably on an image acquired by the tomographic imaging apparatus (typically by a lens and/or a sensor of the tomographic imaging apparatus), and/or
a use of a method for recording, displaying, pixelating, rasterizing, compressing and/or decompressing according to the invention within a tomographic imaging apparatus of an image acquired in several wavelength bands (preferably in the field of health and/or in the field of industry and/or in the field of agriculture), preferably on an image acquired by the tomographic imaging apparatus (typically by a lens and/or a sensor of the tomographic imaging apparatus).

Of course, the invention is not limited to the examples just described, and many adjustments can be made to these examples without going beyond the scope of the invention.

Of course, the various features, forms, variants and embodiments of the invention may be combined with each other in various combinations as long as they are not incompatible or exclusive of each other. In particular, all the variants and embodiments described above can be combined with each other.

1. A method for recording a digital image in a computer format, said image or at least a portion of the image being coded and recorded in the form of a matrix of pixels wherein each subject pixel from among at least one or more pixels of the matrix comprises:
at least one dividing line within the subject pixel, dividing the subject pixel into at least two domains, and/or
at least one spatial gradient of color and/or shade and/or brightness within the subject pixel or at least one of the domains of the subject pixel.

2. The method according to claim 1, characterized in that each dividing line within the subject pixel is coded by two data comprising:
two points on a periphery of the subject pixel, and/or
a distance, preferably from the center of the subject pixel, and an angle.

3. The method according to claim 1, characterized in that the dividing lines of several neighboring pixels are joined together to form a continuous line running through that plurality of neighboring pixels.

4. The method according to claim 1, characterized in that the at least one gradient within the subject pixel or the at least one domain of the subject pixel comprises:
a brightness gradient, and/or
one or more gradients corresponding respectively to one or more color(s) and/or shade(s).

5. The method according to claim 1, characterized in that the at least one gradient within the subject pixel or the at least one domain of the subject pixel is coded by:
two spatial components, or
a single spatial component relative to the at least one dividing line within the subject pixel.

6. The method according to claim 1, characterized in that at least one brightness and/or color and/or shade within the subject pixel or the at least one domain of the subject pixel depends on a brightness and/or color and/or shade of at least one pixel adjacent to the subject pixel or at least one domain of a pixel adjacent to the subject pixel.

7. The method according to claim 1, characterized in that at least one brightness and/or color and/or shade gradient within the subject pixel or the at least one domain of the subject pixel depends on a brightness and/or color and/or shade gradient of at least one pixel adjacent to the subject pixel or at least one domain of a pixel adjacent to the subject pixel.

8. The method according to claim 1, characterized in that all the pixels of the pixel matrix have the same dimensions.

9. The method according to claim 1, characterized in that the at least one dividing line has a state that can be viewed with a viewing area.

10. The method according to claim 9, characterized in that the at least one dividing line itself comprises a spatial gradient enabling its brightness(es) and/or color(s) and/or shade(s) to be modulated, when it can be viewed.

11. The method according to claim 9, characterized in that the at least one dividing line is switched between its viewable state and a non-viewable state.

12. The method according to claim 1, characterized in that the at least one dividing line is switched between an active state and an inactive state.

13. The method according to claim 12, characterized in that it comprises deactivation of the at least one dividing line of the subject pixel if this subject pixel is sampled below a certain spatial sampling threshold.

14. The method according to claim 1, characterized in that it is implemented in an embedded manner in a software module that is added to or integrated with a web browser, for taking into account the recorded images, possibly compressing or decompressing them, and/or displaying them on part or all of a screen in interaction with the web browser.

15. The method according to claim 1, characterized in that:
textual information represented by symbols-pointing in a font, and/or
drawings of embedded objects in the form of raster or vectorized sub-images are added directly to the recorded image or added during its viewing, so that they can be viewed, possibly according to a particular selection which shows only all or part of them, when the recorded image is rendered.

16. The method according to claim 1, characterized in that metadata are added to the recorded image.

17. A method for:
displaying an initial image as a so-called final image on a screen comprising groups of photogenerators, or
pixelating or rasterizing said initial image into a final image comprising final pixels devoid of dividing lines and/or spatial gradients of color and/or shade and/or brightness within said final pixels, said initial image being recorded according to, claim 1, comprising:
for each final subject pixel or each subject group of photogenerators, a transcription of at least one initial pixel or at least one initial pixel domain into this subject final pixel or subject group of photogenerators:
from the brightness and/or color and/or shade components of this at least one initial pixel or at least one initial pixel domain; and
to this subject final pixel or subject group of photogenerators,
with transcription taking place in proportion to this at least one initial pixel or at least one initial pixel domain within a common facing surface between:
this at least one initial pixel or at least one initial pixel domain; and
the subject final pixel or subject group of photogenerators.

18. The method according to claim 17, characterized in that, for transcription purposes, if the subject final pixel or subject group of photogenerators faces different initial pixels and/or domains of initial pixels, its brightness and/or color and/or shade components are a weighted average in proportion to the respective areas of these different initial pixels and/or domains of initial pixels facing the subject final pixel or subject group of photogenerators.

19. The method according to claim 17, characterized in that, for transcription purposes, the brightness and/or color and/or shade components of an initial pixel are modulated by the spatial gradient values of each part of the initial pixel domain facing the subject final pixel or subject group of photogenerators.

20. The method according to claim 17, characterized in that a dividing line of an initial pixel is used to be viewable and contribute to the brightnesses and/or colors and/or shades of at least the subject final pixel or subject group of photogenerators, in proportion to a viewing area of at least a portion of the dividing line facing the subject final pixel or subject group of photogenerators.

21. The method for compressing or decompressing an initial image recorded according to claim 1, characterized in that the initial image is compressed or decompressed, respectively, into a compressed or decompressed image, respectively, by decreasing the volume of information representing the compressed image as a result of the compression, or by increasing the volume of information representing the decompressed image as a result of the decompression, the compression or decompression relating to at least one component among the color(s) and/or the shade(s) and/or the brightness and/or the at least one dividing line and/or the at least one spatial gradient within each subject initial pixel.

22. The method according to claim 21, characterized in that the initial image is respectively compressed or decompressed so that its content can be viewed directly using a method for:
displaying an initial image as a so-called final image on a screen comprising groups of photogenerators, or
pixelating or rasterizing said initial image into a final image comprising final pixels devoid of dividing lines and/or spatial gradients of color and/or shade and/or brightness within said final pixels, comprising:
for each final subject pixel or each subject group of photogenerators, a transcription of at least one initial pixel or at least one initial pixel domain into this subject final pixel or subject group of photogenerators:
from the brightness and/or color and/or shade components of this at least one initial pixel or at least one initial pixel domain; and
to this subject final pixel or subject group of photogenerators,
with transcription taking place in proportion to this at least one initial pixel or at least one initial pixel domain within a common facing surface between:
this at least one initial pixel or at least one initial pixel domain; and
the subject final pixel or subject group of photogenerators.

23. The method according to claim 21, characterized in that the initial image is compressed or decompressed respectively, by means of a wavelet transformation of each component to be compressed.

24. The method according to claim 21, characterized in that the initial image is compressed or decompressed, respectively, by means of a Discrete Cosine Transform (DCT).

25. The method according to claim 21, characterized in that it comprises, after compression or decompression, a search for identical sequences, and an indexing of these sequences and replacement of each repeated sequence by its index in an image data or information stream.

26. The method according to claim 21, characterized in that it uses lossy compression on at least one component among color(s) and/or shade(s) and/or brightness and/or at least one dividing line and/or at least one spatial gradient of each subject initial pixel or of the at least one divide within each subject initial pixel, and lossless on at least one other component among activation of the at least one divide, and/or visualization of the at least one divide and/or width of the at least one divide.

27. A computer program product comprising computer code instructions for executing a method according to claim 1 when said program is executed on a computer.
